(19) United States
(12) Patent Application Publication
(10) Pub. No.: US 2007/0300238 A1
(43) Pub. Date: Dec. 27, 2007

(54) Adapting software programs to operate in software transactional memory environments

(76) Inventors: Leonidas Kontothanassis, Arlington, MA (US); Ali-Reza Adl-tabatabai, Santa Clara, CA (US); Bratin Saha, San Jose, CA (US)

Correspondence Address: Courtney Staniford & Gregory, LLP;Intellevate, P.O. Box 52050, Minneapolis, MN, 55402, US

(21) Appl. No.: 11/471,786

(22) Filed: Jun. 21, 2006

(51) Int. Cl. G06F 9/44

(52) U.S. Cl. 719/320

(57) ABSTRACT

Embodiments of a system and method for adapting software programs to operate in software transactional memory (STM) environments are described. Embodiments include a software transactional memory (STM) adapter system including, in one embodiment, a version of a binary rewriting tool. The STM adapter system provides a simple-to-use application programming interface (API) for legacy languages (e.g., C and C++) that allows the programmer to simply mark the block of code to be executed atomically; the STM adapter system automatically transforms all the binary code executed within that block (including pre-compiled libraries) to execute atomically (that is, to execute as a transaction). In an embodiment, the STM adapter system automatically transforms lock-based critical sections in existing binary code to atomic blocks, for example by replacing locks with begin and end markers that mark the beginning and end of transactions. Other embodiments are described and claimed.

### FIELD OF THE INVENTION

Embodiments are in the field of software transactional memory (STM), and particularly in the field of adapting application programs that were not originally intended to execute in STM environments.

### BACKGROUND OF THE DISCLOSURE

Computer systems and applications continually evolve to be ever more complex and capable. Even fairly inexpensive portable personal computer systems are routinely expected to support video applications, for example. As a result, there is constant pressure on computer hardware and software developers to support increased capability and speed in systems that are affordable and relatively small. One of the responses to this pressure is central processing units (CPUs) with multiple processing cores that perform parallel processing. Parallel processing involves resource sharing among the multiple cores. Handling memory sharing is a significant challenge. For example, consider a situation in which one processing thread modifies the contents of a portion of memory for later use. Before the processing thread uses the modified contents, another processing thread overwrites the portion of memory. If a copy of the modified contents is not stored in another location, a significant delay, or an error, results. Therefore, software mechanisms for multi-core processors and parallel processing have been developed.

One software mechanism suitable for parallel processing is software transactional memory (STM). STM is a concurrency control mechanism for controlling access to shared memory in multi-core computing. STM is analogous to similar control mechanisms for database transactions. STM functions as an alternative to lock-based synchronization, and is typically implemented in a lock-free way. A transaction in this context is a piece of code that executes a series of reads and writes to shared memory. These reads and writes logically occur at a single instant in time, and intermediate states are not visible to other (successful) transactions.

Existing software code that predates STM is usually not well adapted to operate in multi-core, parallel processing systems. In general, older software programs that are outdated in some way are often referred to as legacy programs. Similarly, older types of code are referred to as legacy code. Legacy code does not include mechanisms to ensure that improper memory accesses do not occur and cause errors. Such code includes programs written in languages like C or C++. This is in contrast to languages like Java that provide a managed virtual machine that can be used to implement the transactional mode. For this reason legacy code written in such languages is also referred to as non-managed code. Traditional approaches to providing STM depend on the user to rewrite individual memory accesses manually, an error-prone approach that is not practical for large applications and applications that use pre-compiled libraries. One technique to make legacy programs useable in STM environments is a locking technique. “Locks” are manually inserted around sections of code to prevent any interference by other threads until the lock is released. However, locks are not very efficient because they may cause resources to remain idle until the lock is released, thus defeating the very advantage of parallel processing. In addition, manually inserting locks requires the programmer to take into account, and code for, all of the possible consequences of acquiring and releasing the locks.

Other traditional approaches to providing STM depend on a managed environment that supports a transactional language construct. This precludes the use of legacy languages, existing applications, and existing libraries inside transactions.

### BRIEF DESCRIPTION OF THE DRAWINGS

FIG. 1 is a block diagram of a software transactional memory (STM) adapter system, according to an embodiment.

FIG. 2 is a flow diagram of a method of adapting an application program, according to an embodiment.

FIG. 3 is a flow diagram of a method of transferring control between an application program and a binary rewriting tool, which occurs within the method of FIG. 2, according to an embodiment.

FIG. 4 is a diagram illustrating differences in pseudocode between a lock implementation of an application program, a user-coded transactional memory implementation of an application program, and a binary rewriting transactional memory implementation, according to an embodiment.

### DETAILED DESCRIPTION

Embodiments described herein facilitate the use of software transactional memory in non-managed language environments and with legacy codes without requiring a software programmer to change the programming paradigm they are currently used to. Embodiments combine the benefits of transactional memory, such as simpler concurrency protocols, with the familiarity of traditional programming languages. Transactional memory has been shown to often provide significant performance advantages over traditional locking protocols, particularly when code complexity forces programmers to use coarse grain locking. Embodiments allow the straightforward conversion of legacy code to an equivalent transactional memory version that realizes any concurrency benefits that may exist.

Embodiments described herein combine the benefits of transactional memory (e.g. deadlock elimination, higher concurrency when compared to coarse grain locking) without the need to introduce new language constructs or complicated library calls into existing program code. Furthermore, when combined with automatic lock detection, embodiments can be used to convert legacy codes into transactional memory equivalents without the need to rewrite them. This conversion can provide performance benefits when the original locking discipline was coarse due to program complexity and can be turned off at no cost if its benefits do not outweigh its costs.

In an embodiment, a software transactional memory (STM) adapter system includes a version of a binary rewriting tool (for example the PIN binary instrumentation tool, available from Intel™ Corporation). The STM adapter system provides a simple-to-use application programming interface (API) for legacy languages (e.g., C and C++) that allows the programmer to simply mark the block of code to be executed atomically; the STM adapter system automatically transforms all the binary code executed within that block (including pre-compiled libraries) to execute atomically (that is, to execute as a transaction).

In an embodiment, the STM adapter system automatically transforms lock-based critical sections in existing binary code to atomic blocks, for example by replacing locks with begin and end markers that mark the beginning and end of transactions. In an embodiment, the markers are interpreted as function calls. This allows adaptation of legacy programs to transactional memory versions, even in cases in which the effort to change the source code would be too large, or where the source code is not accessible

Embodiments can also be used in managed languages that already provide an atomic language construct (e.g., the HPCS languages Fortress, Chapel, and X10, or research languages such as Transactional Java and CILK) but need to call out to native code inside a transaction.

In an embodiment, the benefits of transactional memory are evaluated dynamically, and the appropriate codepath (transactional memory or traditional locking) can be chosen based on runtime statistics.

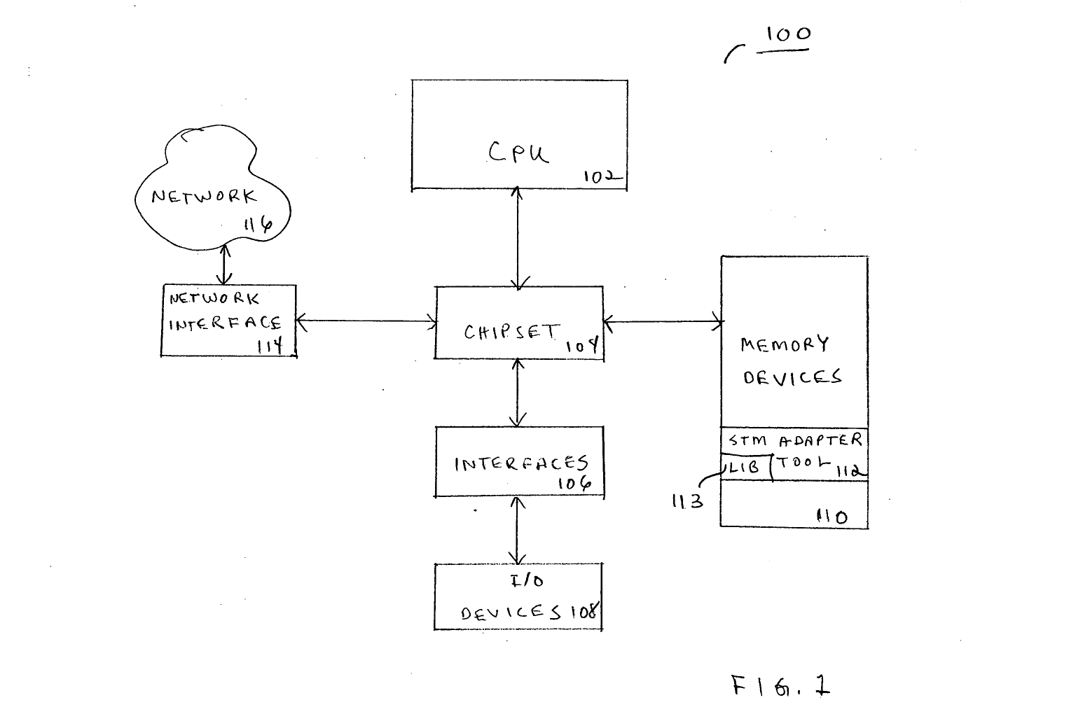

FIG. 1 is a block diagram of elements of a system 100 including a software transactional memory (STM) adapter (SA) tool 112 and STM adapter library 113, according to an embodiment. FIG. 1 is a partial block diagram of an example of a computer system hardware configuration in which embodiments of the invention may be practiced. The system 100 includes at least central processing unit (CPU) 102, a chipset 104, system memory devices 110, one or more interfaces 106 to interface with one or more input/output (I/O) devices 108, and a network interface 114.

The chipset 104 may include a memory control hub (not shown) and/or an I/O control hub (not shown). The chipset 104 may be one or more integrated circuit chips that act as a hub or core for data transfer between the CPU 102 and other components of the system 100. Further, the system 100 may include additional components (not shown) such as other processors (e.g., in a multi-processor system), one or more co-processors, as well as other components.

For the purposes of the present description, the term “processor” or “CPU” refers to any machine that is capable of executing a sequence of instructions and should be taken to include, but not be limited to, general purpose microprocessors, special purpose microprocessors, application specific integrated circuits (ASICs), multi-media controllers, digital signal processors, and micro-controllers, etc

The CPU 102, the chipset 104, and the other components, access memory devices 110 via chipset 104. The chipset 104, for example, with the use of a memory control hub, may service memory transactions that target memory devices 110.

Memory devices 110 may include any memory device adapted to store digital information, such as static random access memory (SRAM), dynamic random access memory (DRAM), synchronous dynamic random access memory (SDRAM), and/or double data rate (DDR) SDRAM or DRAM, etc. Thus, in one embodiment, memory devices 110 include volatile memory. Further, memory devices 110 can also include non-volatile memory such as read-only memory (ROM).

Moreover, memory devices 110 may further include other storage devices such as hard disk drives, floppy disk drives, optical disk drives, etc., and appropriate interfaces.

Further, system 100 may include suitable interfaces 106 to interface with I/O devices 108 such as disk drives, monitors, keypads, a modem, a printer, or any other type of suitable I/O devices.

System 100 may also include a network interface 114 to interface with a network 116 such as a local area network (LAN), a wide area network (WAN), the Internet, etc.

In an embodiment, system 100 includes multiple cores in CPU 102 for multi-threaded processing, or parallel processing. In an embodiment, memory devices 110 store a software transactional memory (STM) adapter tool 112 and STM adapter tool library 113 as further described below. STM adapter tool 112 adapts all types of software applications to operate in the parallel processing system 100 without the use of locks, regardless of whether the applications were originally written to support parallel processing.

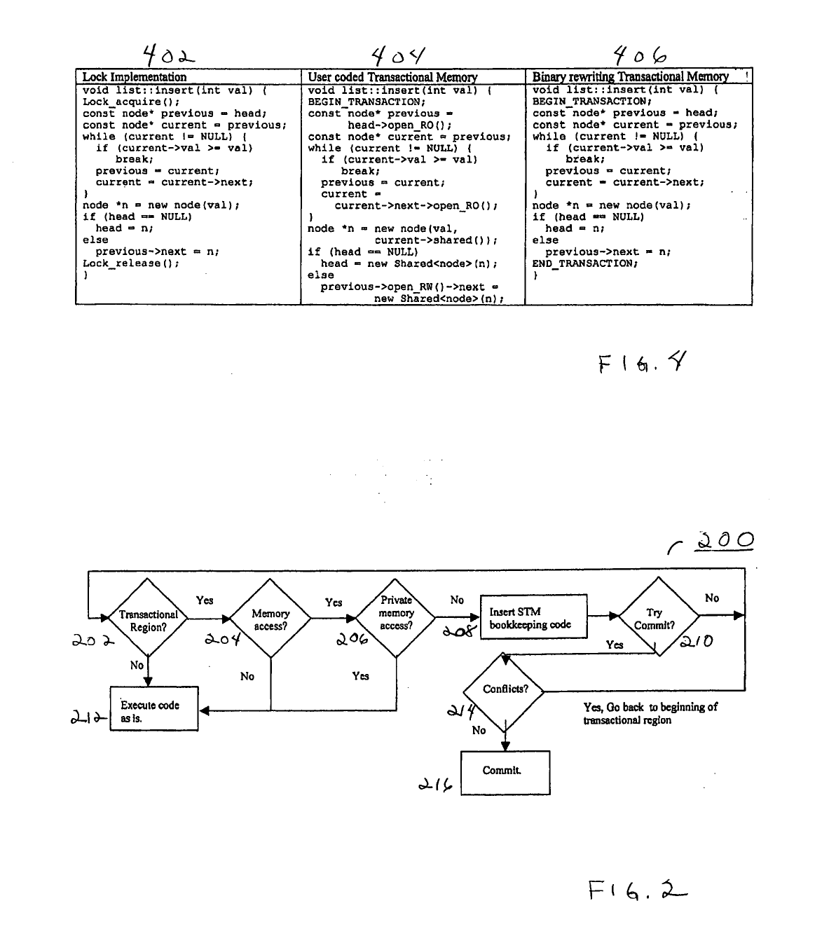

FIG. 2 is a flow diagram of a method 200 of adapting an application program, according to an embodiment. During operation of an STM adapter tool, it is determined whether a transaction region in an application has been encountered at 202. If a transaction region has not been encountered, the application code is executed as it is at 212. If a transaction region is encountered, it is determined at 204 whether there is a memory access. If there is no memory access, the application code is executed as it is at 212.

If there is a memory access, it is then determined at 206 whether the memory access is a private memory access. If the memory access is a private memory access, the application code is executed as it is at 212. If the memory access is not a private memory access, STM bookkeeping code is inserted in the application at 208. STM bookkeeping code, in an embodiment, includes the code for saving state and other code for allowing error-free execution with other execution threads in a multi-core system.

It is then determined at 210 whether the transaction was successful and should be committed. If it is determined that the transaction should not be committed, the process returns to 202. In an embodiment, the process returns to the beginning of the same transaction region. If it is determined that the transaction should be committed, it is determined at 214 whether there are any conflicts. If there are no conflicts, the transaction is committed at 216. If there are conflicts, the process returns to 202 at the beginning of the transaction region.

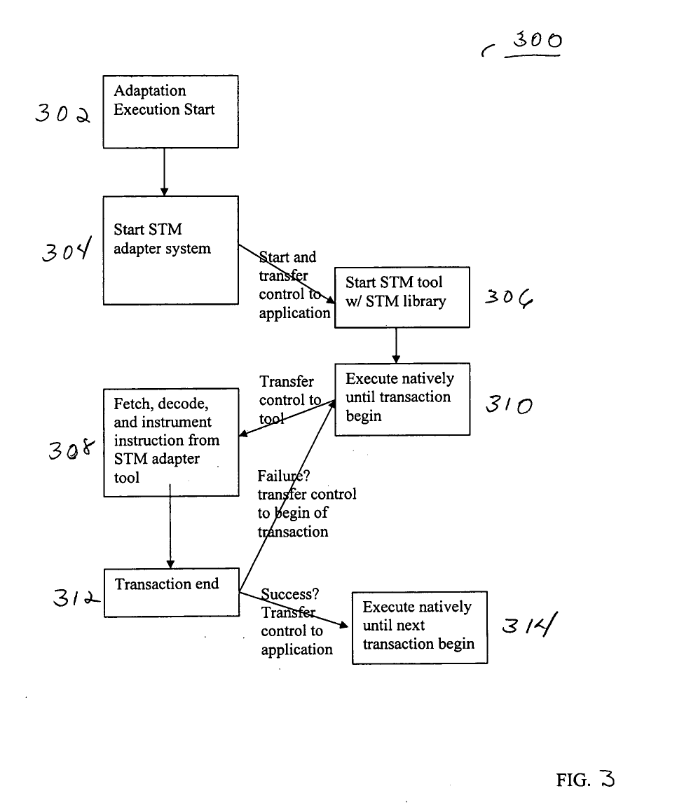

FIG. 3 is a flow diagram of a method 300 of transferring control between an application program and the STM adapter binary rewriting tool, which occurs within the method of FIG. 2, according to an embodiment. Execution of the adaptation of a software application program starts at 302. The STM adapter tool is started at 304, and control is transferred to the application (shown by a right arrow). The STM adapter tool and library are accessed at 306. The application executes natively (in native mode) at 310 until the beginning of a transaction region is encountered. In an embodiment, the beginning of the transaction region is encountered as a marker that has been previously placed. In another embodiment, the beginning of the transaction region is encountered as a lock construct that may be automatically replaced with a beginning of transaction marker.

When the beginning of the transaction region is encountered, control is transferred to the STM adapter tool (shown by a left arrow) to the application. At 308, an instruction is fetched from the STM adapter tool, decoded, and instrumented. At the end of the transaction 312, it is determined whether the transaction succeeded or failed. If the transaction failed, control is transferred to the application (310) at the beginning of the failed transaction. State is also restored. If the transaction succeeded, control is transferred to the application after the transaction, and the application executes natively at 314 until the next transaction is encountered.

In an embodiment, the instrumenting of the instruction (at 304) allows collection of performance data during execution of the program. If performance is not improved as desired by the adaptation process, the transaction markers can be removed on a transaction-by-transaction basis.

FIG. 4 is a diagram illustrating differences in pseudocode between a lock construct implementation (pseudocode 402), of an application program, a user-coded transactional memory implementation (pseudocode 404), of an application program, and a binary rewriting transactional memory implementation (pseudocode 406), according to an embodiment.

Aspects of the methods and systems described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Implementations may also include microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, etc.

The term “processor” as generally used herein refers to any logic processing unit, such as one or more central processing units (“CPU”), digital signal processors (“DSP”), application-specific integrated circuits (“ASIC”), etc. While the term “component” is generally used herein, it is understood that “component” includes circuitry, components, modules, and/or any combination of circuitry, components, and/or modules as the terms are known in the art.

The various components and/or functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list; all of the items in the list; and any combination of the items in the list.

The above description of illustrated embodiments is not intended to be exhaustive or limited by the disclosure. While specific embodiments of, and examples for, the systems and methods are described herein for illustrative purposes, various equivalent modifications are possible, as those skilled in the relevant art will recognize. The teachings provided herein may be applied to other systems and methods, and not only for the systems and methods described above. The elements and acts of the various embodiments described above may be combined to provide further embodiments. These and other changes may be made to methods and systems in light of the above detailed description.

In general, in the following claims, the terms used should not be construed to be limited to the specific embodiments disclosed in the specification and the claims, but should be construed to include all systems and methods that operate under the claims. Accordingly, the method and systems are not limited by the disclosure, but instead the scope is to be determined entirely by the claims. While certain aspects are presented below in certain claim forms, the inventors contemplate the various aspects in any number of claim forms. Accordingly, the inventors reserve the right to add additional claims after filing the application to pursue such additional claim forms for other aspects as well.

What is claimed is:

1. A method for adapting an application program to operate with transactional memory, the method comprising:
identifying blocks of code in the application program to be executed atomically; and
transforming binary code within the blocks to execute atomically, comprising rewriting the blocks of code to include applicable software transactional memory (STM) code sequences.

2. The method of claim 1 further comprising transferring program control from the application program to an adapter tool when encountering the marked blocks of code.

3. The method of claim 1, further comprising:
marking the blocks of code that are to be executed atomically; and
wherein the method is performed automatically, including automatically accessing a binary rewriting tool.

4. The method of claim 1, further comprising:
marking the blocks of code that is to be executed atomically; and
wherein the blocks of code are marked manually, and wherein the binary code is transformed automatically upon execution of the application program.

5. The method of claim 1, wherein the marked blocks of code are executed as transactions in an STM environment.

6. The method of claim 5, further comprising determining whether one of the transactions has executed successfully.

7. The method of claim 6, further comprising:
if the transaction did not execute successfully, transferring control to the application program at the beginning of the transaction; and
restoring a previous state from before the failed execution of the transaction.

8. A system for adapting an application program to operate with transactional memory, the system comprising:
a software transactional memory (STM) adapter tool; and
a plurality of application programming interfaces (APIs) that operate with the STM tool for adapting an application program, wherein adapting comprises marking a block of code that is to execute atomically as a transaction with transaction markers.

9. The system of claim 8, wherein adapting further comprises inserting bookkeeping code in the block of code to allow automatic roll-back of a failed transaction.

10. The system of claim 8, wherein the application is an existing lock-based application program, and wherein adapting the application program further comprises replacing locks with transaction markers.

11. The system of the 8, wherein adapting further comprises transferring control of the application program to the STM adapter tool.

12. The system of claim 11, wherein adapting further comprises determining whether the transaction has executed successfully.

13. The system of claim 12, wherein adapting further comprises, if the application has not executed successfully, transferring control back to the application program at the beginning of the transaction and restoring a previous state.

14. The system of claim 13, wherein adapting further comprises, if the application has executed successfully, transferring control back to the application program after the transaction.

15. A computer-readable medium having stored thereon instructions which when executed in a system cause the system to perform a method, the method comprising:
reading a begin marker in a native language application program, wherein the begin marker indicates a start of a transaction, wherein a transaction comprises a section of native language code in the application program to be executed as a transaction; and
within the transaction, performing a call to a native language code library.

16. The medium of claim 15, wherein the method further comprises transferring control of the application program to a binary rewriting adapter tool upon encountering the begin marker.

17. The medium of claim 15, wherein the method further comprises:
upon reading the begin marker, transferring control of the application program to a binary rewriting tool and accessing binary rewriting libraries; and
rewriting the application program to facilitate execution in a software transactional memory (STM) environment.

18. The medium of claim 15, wherein the method further comprises:
upon reading the begin marker, transferring control of the application program to a binary rewriting tool and accessing binary rewriting libraries;
rewriting the application program to facilitate execution in a software transactional memory (STM) environment; and
inserting an end marker to indicate the end of the transaction.

19. The medium of claim 18, wherein the method further comprises:
during execution of the application program, determining whether the transaction executed successfully; and
if the transaction did not execute successfully, transferring control to the application program at the beginning of the transaction and restoring a previous state.

20. The medium of claim 19, wherein the method further comprises:
collecting performance data during execution of the application program; and
if performance of the application program is poorer after insertion of the begin marker and the end marker, removing the begin marker and the end marker.
